(19) United States
(12) Patent Application Publication
(10) Pub. No.: US 2026/0194128 A1
(43) Pub. Date: Jul. 9, 2026

(54) STEERING DEVICE AND METHOD FOR MANUFACTURING STEERING DEVICE

(71) Applicant: KNORR-BREMSE COMMERCIAL VEHICLE SYSTEMS JAPAN LTD., Sakado-shi, Saitama (JP)

(72) Inventors: Takafumi OHATA, Hiki-gun, Saitama (JP); Shogo ISHIKAWA, Hiki-gun, Saitama (JP)

(73) Assignee: KNORR-BREMSE COMMERCIAL VEHICLE SYSTEMS JAPAN LTD., Sakado-shi, Saitama (JP)

(21) Appl. No.: 19/129,723

(22) PCT Filed: Nov. 15, 2023
(86) PCT No.: PCT/JP2023/041055

§ 371 Date: May 14, 2025

(30) Foreign Application Priority Data
Nov. 15, 2022 (JP) 2022-182216

(51) Int. Cl. F16H 19/04; B62D 3/02

(52) U.S. Cl. CPC F16H 19/04; B62D 3/02; F16H 2019/046

(57) ABSTRACT

In a steering device (PS1) according to the present invention, a preload applying mechanism (6) is configured to apply rotation torque in one rotation direction of a ball nut (4) based on the reaction force generated by a plunger (61) coming in elastic contact with the tooth tip of a first sector tooth (321) of a sector gear (32). Consequently, in the steering device (PS1), unlike conventional steering devices, it is not necessary to provide a pushed part which is pushed by the plunger (61), separately from the sector gear (32). With this, it is possible to suppress an increase in the size of a sector shaft (3) due to the formation of the pushed part.

### TECHNICAL FIELD

The present invention relates to a steering device and a method for manufacturing the steering device.

### BACKGROUND TECHNOLOGY

A conventional steering device described, for example, in a patent document 1 described below has been known.

That is, the steering device according to the following patent document 1 is configured in a manner that a steering shaft linked to a steering wheel and a sector shaft linked to a turning wheel are arranged intersecting with each other, and rack tooth part formed on a ball nut screwed onto the steering shaft and a sector gear provided on the sector shaft mesh with each other.

In addition, a preload applying mechanism is provided between the ball nut and the sector shaft to adjust the backlash between the rack tooth part and the sector gear at the neutral position of the sector shaft. This preload applying mechanism includes a plunger that is embedded in the ball nut together with an energizing member at a position opposite to an end portion in the axial direction of the sector gear and is energized on the sector gear side via the energizing member, and a plunger sliding portion provided to the sector shaft that has a cam profile that can come in elastic contact with the plunger within a predetermined rotation range with the neutral position of the sector shaft as a center. That is, the preload applying mechanism energizes the ball nut in one rotation direction based on the reaction force from the plunger sliding portion which is generated when the plunger comes in elastic contact with the plunger sliding portion, within a predetermined range with the neutral position of the sector shaft as a center. With this, the preload applying mechanism can reduce the backlash between the rack tooth part and the sector gear near the neutral position of the sector shaft.

### PRIOR ART DOCUMENT(S)

### Patent Document(s)

Patent Document 1: Japanese Patent Application Publication No. H05-319285

### Problems to be Solved by the Invention

However, in the conventional steering device described above, it is necessary to provide a plunger sliding portion separately from the sector gear. Therefore, the size of the sector shaft in the axial direction is increased by the plunger sliding portion, and there is still room for improvement in this respect.

The present invention has been made into consideration of such a technical problem, and an object of the present invention is to provide a steering device and a method for manufacturing the steering device which can reduce the size of the sector shaft.

### Means for Solving the Problem

The present invention, in one aspect thereof, a steering device includes: a rack tooth part formed on an outer side of a ball nut which is screwed onto a steering shaft linked to a steering wheel; a sector gear which is provided to a sector shaft linked to a turning wheel, includes a center tooth that meshes most deeply with the rack tooth part at a neutral position of the sector shaft which corresponds to a straight-ahead steering state, and meshes with the rack tooth part using a plurality of sector teeth provided in a circumferential direction of the sector shaft; and a preload applying mechanism which adjusts a meshing between the rack tooth part and the sector gear in a vicinity of the neutral position of the sector shaft wherein the preload applying mechanism includes: a plunger receiving hole which is provided close to an area on one end side in a tooth width direction of a specific tooth bottom of the rack tooth part which faces a tooth tip of the center tooth in the vicinity of the neutral position of the sector shaft, and is opened to the specific tooth bottom; a plunger which is housed in the plunger receiving hole so as to advance and retract, and is provided such that a distal end side thereof protrudes from an opening facing the sector gear of the plunger receiving hole; a sliding ring which is provided to move integrally with the plunger by being press-fitted to an outer peripheral side of the plunger, and slides with respect to an inner peripheral surface of the plunger receiving hole by the advance and retraction movement of the plunger; and an energizing member which is interposed between a bottom of the plunger receiving hole and the sliding ring, and energizes the plunger toward the center tooth via the sliding ring, and wherein the preload applying mechanism energizes the ball nut in one rotation direction of the ball nut based on a reaction force generated by the plunger coming in elastic contact with the tooth tip of the center tooth.

In this way, in the present invention, the plunger energized by the energizing member comes in contact with the tooth tip of the center tooth of the sector gear, and a rotational torque that acts as preload on the ball nut is applied. Accordingly, in this invention, it is not necessary to provide a pushed part that is pushed by the preload applying mechanism separately from the sector gear, as in the conventional device, and it is possible to suppress the sector shaft from becoming larger due to the formation of the pushed part.

In addition, in another aspect of the steering device, it is desirable that a connection of the sliding ring and the plunger by the press-fitting regulates a relative movement of the plunger to the sliding ring with respect to an energizing force of the energizing member, while allowing the relative movement of the plunger to the sliding ring with respect to a meshing force of the sector gear with the rack tooth part.

In case where the sliding ring is formed integrally with the plunger, for example, depending on the processing accuracy (processing error) of the plunger which comes in contact with the center tooth of the sector gear and the plunger receiving hole which accommodates the plunger, there is a possibility that the length of the plunger that faces more on the sector gear side than the sliding ring becomes longer than necessary. Consequently, the plunger is excessively pushed in when the sector gear meshes with the rack tooth part, as a result of which the energizing member is excessively compressed, and damage to the energizing member or a deterioration in its lifespan might occur.

In contrast to this, in the present invention, the sliding ring is press-fitted to the plunger at a fitting degree that allows the relative movement of the sliding ring and the plunger with respect to the meshing force of the sector gear and rack tooth part, while regulating the relative movement of the sliding ring and the plunger with respect to the energizing force of the energizing member. With this, the sliding ring and the plunger integrally move depending on the energizing force of the energizing member, and when the sector gear meshes with rack tooth part, the plunger is pushed in the direction opposite to the advancing direction by the sector gear, and the plunger moves relative to the sliding ring, thereby allowing the positional relationship between the plunger and the sliding ring to be changed to an appropriate relative position. As a result, the plunger is energized to the sector gear with an appropriate force, and an appropriate preload can be applied to the ball nut, regardless of machining errors in the axial dimensions of the plunger receiving hole, plunger and sliding ring.

In addition, the relative movement between the sliding ring and the plunger with respect to the meshing force of the sector gear and the rack tooth part is allowed, and there is no risk of the energizing member being excessively compressed due to the meshing between the sector gear and the rack tooth part. Consequently, the damage to the energizing member is suppressed and the durability of the energizing member is also improved.

In addition, in still another aspect of the steering device, it is desirable that the plunger receiving hole includes, at the bottom on a side opposite to the opening, a recess portion which can receive an end portion of the plunger which is located on a side opposite to a distal end portion of the plunger that comes in contact with the tooth tip of the center tooth.

Depending on the length of the end portion of the plunger that faces more on the energizing member side than the sliding ring, when the plunger is pushed in by the center tooth, the end portion of the plunger might come in contact with the bottom of the plunger receiving hole, and the plunger may be prevented from being pushed in (retraction movement).

In contrast, in the present invention, a recess which can receive the end portion of the plunger which is located on the side opposite to the distal end portion of the plunger that comes in contact with the center tooth of the sector gear is provided at the bottom on a side opposite to the opening of the plunger receiving hole. With this, when the plunger is pushed in by the center tooth, the end portion of the plunger is received in the recess, thereby eliminating the risk that the end portion of the plunger comes in contact with the bottom of the plunger receiving hole and the plunger is prevented from being pushed in (retracted). Consequently, it is possible to adjust the relative position of the plunger and the sliding ring to an appropriate state, regardless of the length of the end portion of the plunger that faces more on the energizing member side than the sliding ring.

In addition, in still another aspect of the steering device, it is desirable that the plunger receiving hole is reduced in diameter such that the opening has an inner diameter smaller than an outer diameter of the sliding ring, and includes a stopper which regulates a protrusion amount of the plunger by coming in contact with the sliding ring, in a state in which a rotational phase of the sector shaft is in the vicinity of the neutral position, the sliding ring does not come in contact with the stopper, and a contact between the plunger and the center tooth is allowed, and in a state in which the rotational phase of the sector shaft exceeds the vicinity of the neutral position, the sliding ring comes in contact with the stopper and the contact between the plunger and the center tooth is regulated.

In this way, in the present invention, when the rotational phase of the sector shaft is near the neutral position, the contact between the plunger and the center tooth is allowed, and when the rotational phase of the sector shaft exceeds the vicinity of the neutral position, the contact between the plunger and the center tooth is regulated by the stopper. In this way, by regulating the protrusion amount of the plunger with the stopper, it is possible to adjust the meshing of the rack tooth part and the sector gear only in the vicinity of the steering neutral position, where rigidity is required. In other words, outside the vicinity of the steering neutral position, where rigidity is not particularly required, by regulating the contact between the plunger and the central tooth, it is possible to suppress the deterioration of the steering feel, such as so-called “grinding” feeling that occurs when the plunger slidably comes in contact with the central tooth.

In addition, in the present invention, the stopper is configured by simply narrowing the opening of the plunger receiving hole. With this, it is possible to regulate the protrusion amount of the plunger with a relatively simple configuration, without forming a complex cam profile as a conventional one, thereby contributing to reducing the manufacturing cost of the steering device.

In addition, in still another aspect of the steering device, it is desirable that a tooth bottom of the sector gear has a flat surface that is parallel to a rotation axis of the sector shaft.

In this way, in the present invention, the tooth tip of the center tooth that the plunger comes in contact with has a straight shape parallel to the axis of the sector shaft. That is, unlike the conventional one, the rack tooth part and the sector gear in the present invention do not have a tapered gear shape, and the meshing of the rack tooth part and the sector gear is adjusted using only the preload applying mechanism, without providing a mechanism for adjusting the meshing of the rack tooth part and the sector gear in addition to the preload applying mechanism. With this, the configuration of the steering device is simplified, thereby contributing to improvement in productivity and reducing of manufacturing costs for the steering device.

In addition, in still another aspect of the steering device, it is desirable that a tooth bottom of the sector gear has a tapered surface in which a tooth height of the sector gear gradually increases toward one end side in an axial direction of the sector shaft, and the sector shaft is movable toward one end side in the axial direction of the sector shaft by an adjustment screw screwed from an other end portion in the axial direction of the sector shaft through a female screw hole formed in an end wall of a housing that houses the sector shaft.

In this way, in the present invention, the rack tooth part and the sector gear have a tapered gear shape, and it is possible to adjust the meshing between the rack tooth part and the sector gear by moving the sector shaft in the axial direction toward one end side using the adjusting screw. With this, it is possible to ensure appropriate meshing between the rack tooth part and the sector gear not only in the vicinity of the neutral position of the sector shaft, but also throughout the entire rotation range of the sector shaft.

In addition, in still another aspect of the steering device, it is desirable that one end side in an axial direction of the sector shaft across the sector gear which is connected to a pitman arm is formed to have a relatively large diameter and an other end side in the axial direction across the sector gear is formed to have a smaller diameter than that on one side in the axial direction of the sector shaft, and the plunger receiving hole is opened at an end portion of end portions in the tooth width direction of the specific tooth bottom which corresponds to the other end side in the axial direction of the sector shaft.

In this way, in the present invention, the plunger receiving hole that composes the preload applying mechanism is arranged on the side where the sector shaft has a relatively small diameter, and the preload applying mechanism can be arranged at a position that is relatively far from the rotation center of the ball nut. With this, a larger rotation torque can be applied to the ball nut, and the meshing of the rack tooth part and the sector gear can be adjusted more effectively.

In addition, in still another aspect of the steering device, it is desirable to include: an energizing member assembly operation in which the energizing member is housed in the plunger receiving hole; a sliding ring assembly operation in which the sliding ring is assembled to the plunger; a plunger assembly operation in which the plunger assembled with the sliding ring is assembled to the plunger receiving hole; and a plunger adjustment operation in which the sector gear meshes with the rack tooth part and a relative position of the plunger and the sliding ring is adjusted, after the plunger assembly operation, wherein the plunger adjustment operation includes: a first step in which the sector gear is rotated in one direction with respect to the rack tooth part to which the preload applying mechanism is assembled, and the sector gear is meshed in a non-neutral position; a second step in which the sector gear is rotated in a direction where a distance between the center tooth and the specific tooth bottom becomes small, toward the neutral position, and the center tooth pushes the plunger in a direction opposite to an energizing direction of the energizing member against an energizing force of the energizing member, to compress the energizing member until being maximally contracted via the sliding ring which moves integrally with the plunger, after the first step; and a third step in which in a state in which the energizing member is maximally contracted, the center tooth further pushes the plunger in the direction opposite to the energizing direction of the energizing member, and the plunger is moved relative to the sliding ring in the direction opposite to the energizing direction of the energizing member, after the second step.

In this way, in the plunger adjustment operation in the present invention, the center tooth pushes the plunger further when the energizing member is maximally compressed, to move the plunger relative to the sliding ring, and the positional relationship between the plunger and the sliding ring can be changed to an appropriate relative position. With this, the plunger can be energized to the sector gear with an appropriate force, and an appropriate preload can be applied to the ball nut, regardless of machining errors in the axial dimensions of the plunger receiving hole, plunger, and sliding ring.

In addition, in the plunger adjustment operation, when the center tooth pushes the plunger further in a state in which the energizing member is maximally compressed, the relative movement of the plunger to the sliding ring is allowed, and even if the protrusion amount of the plunger becomes larger than a specified dimension due to, for example, machining errors in the axial dimensions of the plunger receiving hole, plunger and sliding ring, there is no risk of the energizing member being excessively compressed. With this, the energizing member is suppressed from being damaged and the durability of the energizing member is also improved.

In addition, in still another aspect of the steering device, it is desirable that the plunger receiving hole includes, at the bottom on the side opposite to the opening, a recess portion which can receive an end portion of the plunger which is located on a side opposite to a distal end portion of the plunger that comes in contact with the tooth tip of the center tooth, and in the third step, when the plunger moves relative to the sliding ring in the direction opposite to the energizing direction of the energizing member, the end portion of the plunger is received in the recess portion.

In the third step, depending on the length of the end portion of the plunger that faces more on the energizing member side than the sliding ring, when the plunger is pushed in by the center tooth, the end portion of the plunger might come in contact with the bottom of the plunger receiving hole, and there is a risk that the push-in (retraction movement) of the plunger is obstructed.

In contrast, in the present invention, a recess which can receive the end portion of the plunger which is located on the side opposite to the distal end portion of the plunger that comes in contact with the center tooth of the sector gear is provided at the bottom on the side opposite to the opening of the plunger receiving hole. With this, when the plunger is pushed in by the center tooth in the third step, the end portion of the plunger is received in the recess, thereby eliminating the risk that the end portion of the plunger comes in contact with the bottom of the plunger receiving hole and the plunger is prevented from being pushed in (retracted). Consequently, it is possible to adjust the relative position of the plunger and the sliding ring to an appropriate state, regardless of the length of the end portion of the plunger that faces more on the energizing member side than the sliding ring.

### Effect of the Invention

According to the present invention, the preload applying mechanism applies rotation torque to the ball nut by coming in elastic contact with the tooth tip of the center tooth of the sector gear. With this, it is not necessary to provide a pushed part which is pushed by the preload applying mechanism, separately from the sector gear, thereby suppressing an increase in the size of the sector shaft due to formation of the pushed part.

### BRIEF DESCRIPTION OF THE DRAWINGS

FIG. 1 is a sectional view of a steering device according to a first embodiment of the present invention.

FIG. 2 is a sectional view taken along an A-A line of FIG. 1.

FIG. 3 is an enlarged view of a main part in FIG. 1.

FIG. 4 is a diagram showing a change in the protrusion amount of a plunger according to a steering state, where (a) shows a neutral state with a steering angle of 0 degrees, (b) shows a steering state with a steering angle of 12 degrees, and (c) shows a steering state with a steering angle of 25 degrees.

FIG. 5 is a diagram showing a plunger adjustment operation in a method for manufacturing the steering device according to the present invention, where (a) shows a first step, (b) shows a second step, (c) shows a third step, and (d) shows the maximum advancement state of the plunger after the adjustment of the plunger.

FIG. 6 shows a second embodiment of the steering device according to the present invention, and is a sectional view of the steering device corresponding to the A-A line sectional view of FIG. 1.

### MODE FOR IMPLEMENTING THE INVENTION

In the following, an embodiment of a steering device and a method for manufacturing the steering device according to the present invention will be explained based on the drawings. In addition, in the following embodiments, as an example, there is shown that the steering device and the method for manufacturing the steering device are applied to a so-called integral-type power steering device used in large vehicles such as trucks.

### FIRST EMBODIMENT

### (Configuration of Steering Device)

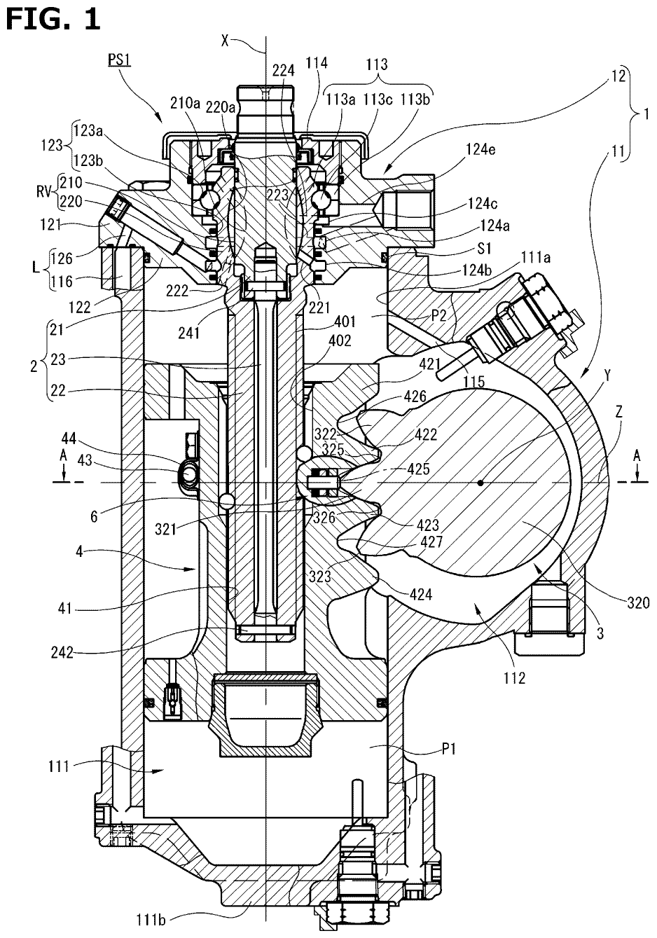

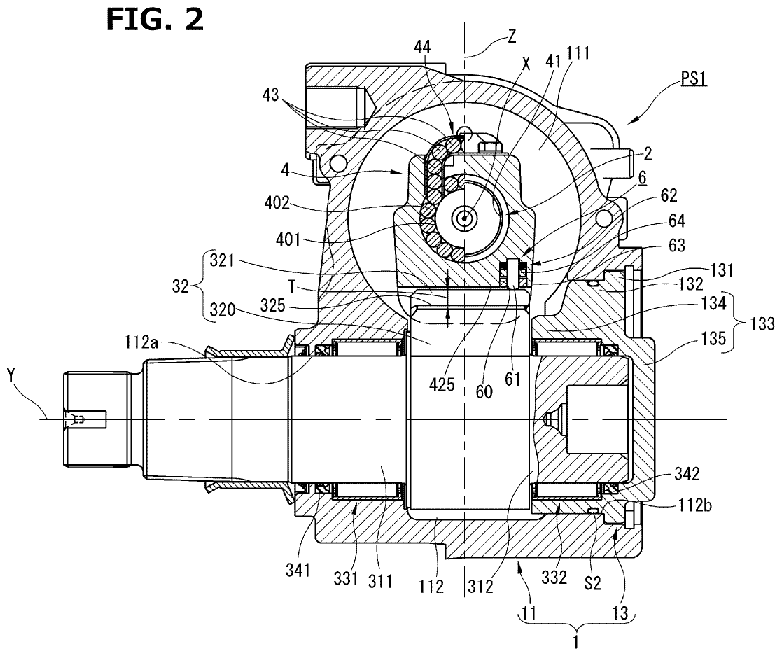

FIG. 1 shows a first embodiment of a steering device according to the present invention, and is a sectional view of a steering device PS1 which is taken along the rotation center of a steering shaft 2. FIG. 2 is a sectional view of the steering device PS1 which is taken along an A-A line of FIG. 1. In addition, in the following, in the direction of a rotation axis X of the steering shaft 2 in FIG. 1, the side that is linked to a steering wheel (not shown) is referred to as the “one end side”, and the side that is linked to a ball nut 4 is referred to as the “other end side”. Further, in the direction of a rotation axis Y of a sector shaft 3 in FIG. 2, the side that is linked to a turning wheel (not shown) is referred to as the “one end side”, and the side that is linked to the ball nut 4 is referred to as the “other end side”.

As shown in FIGS. 1 and 2, the steering device PS1 is a well-known ball-nut type steering device, and includes a steering shaft 2 that is linked to a steering wheel not shown in the drawings, and a sector shaft 3 that is linked to a turning wheel not shown in the drawings. The steering shaft 2 and the sector shaft 3 are housed inside a housing 1. In addition, a ball nut 4 is interposed between the steering shaft 2 and the sector shaft 3, and the rotation of the steering shaft 2 is converted into the rotation of the sector shaft 3 via the ball nut 4.

The housing 1 includes a first housing 11, a second housing 12, and a third housing 13. The first housing 11 functions as a housing body which houses, thereinside, the steering shaft 2, the sector shaft 3, and the ball nut 4. That is, the first housing 11 has a substantially cylindrical steering shaft housing part 111 which extends in the direction of the rotation axis X and houses the steering shaft 2 and the ball nut 4, and a substantially cylindrical sector shaft housing part 112 which extends in the direction of the rotation axis Y, which is orthogonal to the rotation axis X, and houses the sector shaft 3.

As shown in FIG. 1, the steering shaft housing part 111 has a cylindrical shape with a bottom, and one end side in the direction of the rotation axis X of the steering shaft housing part 111 is opened to the outside via a first opening 111a, and the other end side is closed by an end wall 111b. The first opening 111a is closed by the second housing 12 which is fit to the first opening 111a.

The second housing 12 has a cylindrical shape with an outer diameter which is stepwisely reduced towards the other end side, and includes a second housing main body part 121 which comes in contact with the end surface of the first opening 111a, and a second housing fitting part 122 which has a diameter stepwisely reduced relative to the second housing main body part 121 and is fit to the first opening 111a. In addition, a first seal member S1 which can come in elastic contact with the inner peripheral surface of the first opening 111a is attached to the outer periphery of the second housing fitting part 122. Accordingly, the first seal member S1 comes in elastic contact with the inner peripheral surface of the first opening 111a, thereby maintaining the inside of the steering shaft housing part 111 in a liquid-tight state.

In addition, the second housing 12 has a steering shaft insertion hole 123 that penetrates the center of the second housing 12, and the steering shaft 2 is inserted from the outside into the steering shaft housing part 111 through the steering shaft insertion hole 123. The steering shaft insertion hole 123 is configured such that the inner diameter stepwisely decreases from one end side to the other end side, and has a large diameter hole portion 123a having a relatively large diameter shape at one end side and a small diameter hole portion 123b having a relatively small diameter shape at the other end side. In addition, the large diameter hole portion 123a of the steering shaft insertion hole 123 accommodates a steering shaft bearing 113 which is formed, for example, by a ball bearing, and the steering shaft 2 is rotatably supported by this steering shaft bearing 113.

In addition, the steering shaft bearing 113 includes an inner race 113a which is integrally formed with the second steering shaft 22, an outer race 113b which is inserted into the large diameter hole portion 123a, and a plurality of ball members 113c which are interposed between the inner race 113a and the outer race 113b. Further, the outer race 113b is held in a state in which the axial movement is regulated by a lock nut 114 screwed into the large diameter hole portion 123a.

As shown in FIG. 2, the sector shaft housing part 112 is arranged in a substantially tangential position with respect to the steering shaft housing part 111, and is configured to be in communication with the steering shaft housing part 111 by sharing part of the sector shaft housing part 112 in the circumference direction with the steering shaft housing part 111. In addition, one end side in the direction of the rotation axis Y of the sector shaft housing part 112 is opened to the outside via a second opening 112a, and the other end side is opened to the outside via a third opening 112b.

That is, in the sector shaft housing part 112, one end of the sector shaft 3 inserted into the sector shaft housing part 112 via the third opening 112b protrudes outside via the second opening 112a, and is connected to a pitman arm outside the housing 1, which is not shown in the drawings. On the other hand, the third opening 112b is closed by the third housing 13, which is fit to the third opening 112b after the sector shaft 3 is inserted into the sector shaft housing part 112 via the third opening 112b.

The third housing 13 has a cylindrical shape with an outer diameter which is stepwisely reduced toward one end side, and includes a third housing main body part 131 that comes in contact with the end surface of the third opening 112b, and a third housing fitting part 132 having a diameter which is stepwisely reduced relative to the third housing main body part 131 and is fit to the third opening 112b. A second seal member S2, which can come in elastic contact with the inner peripheral surface of the third opening 112b, is attached to the outer periphery of the third housing fitting part 132. Accordingly, the second seal member S2 comes in elastic contact with the inner peripheral surface of the third opening 112b, thereby maintaining the inside of the sector shaft housing part 112 in a liquid-tight state.

In addition, a shaft support part 133 having a cylindrical shape with a bottom that rotatably supports the other end portion of the sector shaft 3 is provided on the inner peripheral side of the third housing fitting part 132. The shaft support part 133 includes a third housing cylindrical portion 134 which is opened at one end side, and a third housing end wall 135 which closes the other end side of the third housing cylindrical portion 134.

As shown in FIG. 1, the steering shaft 2 includes a first steering shaft 21, one end of which is connected to a steering wheel not shown in the drawings, and a second steering shaft 22 which is connected to the other end of the first steering shaft 21 so as to be relatively rotatable via a torsion bar 23, such that part of the second steering shaft 22 overlaps with the first steering shaft 21 in the radial direction. The first steering shaft 21 is connected to the torsion bar 23 via a first pin member 241, which is penetrated in the radial direction, at the other end portion of the first steering shaft 21. Similarly, the second steering shaft 22 is connected to the torsion bar 23 via a second pin member 242, which is penetrated in the radial direction, at the other end portion of the second steering shaft 22.

In addition, although the illustration is omitted in the present embodiment, the steering shaft 2 may be mechanically connected to the steering wheel not shown, or may be electrically connected to the steering wheel not shown, as in the well-known steer-by-wire system. Furthermore, in addition to the mode in which the steering shaft 2 is connected to the steering wheel not shown such that steering torque is input via the steering wheel by manual operation, the mode in which the steering shaft 2 is connected to a motor not shown such that steering torque is input via the motor by automatic operation can also be applied. In addition, the mode of the above-mentioned manual operation includes one in which steering torque is input from the steering wheel not shown, and steering assist torque is input from the motor not shown.

As shown in FIG. 2, the sector shaft 3 includes a sector shaft part 31 which extends along the direction of the rotation axis Y that intersects the rotation axis X of the steering shaft 2 at a substantially right angle, and a sector gear 32 which is arranged facing the ball nut 4 at the other end portion of the sector shaft part 31. The sector shaft part 31 and the sector gear 32 are integrally formed, and the sector shaft part 31 rotates together with the sector gear 32 as the sector gear 32 rotates.

As shown in FIG. 2, the sector shaft part 31 includes a first shaft portion 311 provided more on one end side than the sector gear 32, and a second shaft portion 312 provided more on the other end side than the sector gear 32. In the present embodiment, the first shaft portion 311 and the second shaft portion 312 are set to have approximately the same outer diameter.

One end side of the first shaft portion 311 is connected to a pitman arm, which is not shown in the drawings, and the other end side is rotatably supported by a first bearing 331 which is housed in the inner peripheral side of the second opening 112a. In addition, a first seal member 341 is disposed on one end side of the first bearing 331 to liquid-tightly seal between the outer peripheral surface of the first shaft portion 311 and the inner peripheral surface of the second opening 112a. With this, the hydraulic fluid that has been filled inside the housing 1 (sector shaft housing part 112) is suppressed from leaking out through the second opening 112a.

On the other hand, the second shaft portion 312 is rotatably supported by a second bearing 332 which is housed in the inner peripheral side of the third housing cylindrical portion 134. In addition, a second seal member 342 is provided on the other end side of the second bearing 332 to liquid-tightly seal between the outer peripheral surface of the second shaft portion 312 and the inner peripheral surface of the third housing cylindrical portion 134. With this, the hydraulic fluid that has been filled inside the housing 1 (sector shaft housing part 112) is suppressed from leaking out through the after-mentioned female screw hole 136.

As shown in FIGS. 1 and 2, the sector gear 32 is provided between the first shaft portion 311 and the second shaft portion 312, and includes a connecting base portion 320 connected to the first shaft portion 311 and the second shaft portion 312, and a first sector tooth 321, a second sector tooth 322, and a third sector tooth 323 provided so as to face a rack tooth part 42 of the ball nut 4 at the side part of the connection base portion 320. The first sector tooth 321 protrudes along the direction of a meshing line Z which is perpendicular to the rotation axes X and Y, in the neutral state of the sector gear 32. The second sector tooth 322 protrudes diagonally to the right of the first sector tooth 321 toward one end side of the rotation axis X. The third sector tooth 323 protrudes diagonally to the left of the first sector tooth 321 toward the other end side of the rotation axis X.

In addition, as shown in FIG. 2, in the present embodiment, the tooth bottom of the sector gear 32 is a flat surface parallel to the rotation axis Y, such that a tooth height T of the sector gear 32 is constant in the tooth width direction. In other words, in the present embodiment, the tooth bottom of the sector gear 32 is configured to be a straight shape parallel to the rotation axis Y.

As shown in FIGS. 1 and 2, the ball nut 4 has a cylindrical shape and is formed with a shaft hole 41 along the direction of the rotation axis X. In other words, the ball nut 4 is provided to advance and retract in the direction of the rotation axis X via a plurality of balls 43 interposed between a shaft-side ball groove 401 provided on the outer peripheral side of the second steering shaft 22 housed in the steering shaft housing part 111 and a nut-side ball groove 402 provided on the inner peripheral side of the ball nut 4 (shaft hole 41).

In addition, on the outer peripheral part of the ball nut 4, the rack tooth part 42 (first rack tooth 421, second rack tooth 422, third rack tooth 423 and fourth rack tooth 424, which will be described below) that meshes with the sector gear 32 is formed within a predetermined range facing the sector gear 32. On the other hand, on the back side of the rack tooth part 42 in the outer peripheral part of the ball nut 4, namely, on the side opposite to the rack tooth part 42 across the rotation axis X, a cylindrical tube member 44 is disposed to connect one end portion and the other end portion of the nut-side ball groove 402 to serve for circulating the plurality of balls 43 described above.

As shown in FIG. 1, the rack tooth part 42 includes a first rack tooth 421, a second rack tooth 422, a third rack tooth 423, and a fourth rack tooth 424, which are arranged in parallel along the direction of the rotation axis X on the side facing the sector gear 32 of the ball nut 4. A first rack tooth bottom 425, which is a specific tooth bottom facing the first sector tooth 321 that is a center tooth, is formed between the second rack tooth 422 and the third rack tooth 423. A second rack tooth bottom 426 which faces the second sector tooth 322 is formed between the first rack tooth 421 and the second rack tooth 422. A third rack tooth bottom 427 which faces the third sector tooth 323 is formed between the third rack tooth 423 and the fourth rack tooth 424.

In addition, the ball nut 4 functions as a piston of a power cylinder that is operated by the hydraulic pressure of the hydraulic fluid filled in the steering shaft housing part 111, and is slidably provided in the steering shaft housing part 111. In other words, the ball nut 4 defines two hydraulic pressure chambers, a first hydraulic pressure chamber P1 and a second hydraulic pressure chamber P2, which are located inside the steering shaft housing 111 and arranged facing each other across the ball nut 4 in the direction of the rotation axis X. The second hydraulic pressure chamber P2 is configured to communicate with the sector shaft housing part 112 via a through hole 115 provided in the first housing 11, and the hydraulic fluid in the second hydraulic pressure chamber P2 is guided into the sector shaft housing part 112, thereby enabling lubrication between the sector gear 32 and the rack tooth part 42.

In addition, a well-known rotary valve RV is configured inside the second housing 12 as a control valve that can selectively supply the hydraulic fluid supplied by an external hydraulic pressure source (for example, a pump) to the first hydraulic pressure chamber P1 or the second hydraulic pressure chamber P2 of the power cylinder according to the relative rotation of the first steering shaft 21 and the second steering shaft 22. The rotary valve RV includes a rotor 210 integrally formed with the other end portion of the first steering shaft 21, and a sleeve 220 provided on the outer peripheral side of the rotor 210 and integrally formed with one end portion of the second steering shaft 22.

On the inner peripheral side of the second housing 12, an introduction port 124a, a supply port 124b, and a discharge port 124c, which are circumferential grooves extending in the circumferential direction of the rotation axis X are provided in parallel in the direction of the rotation axis X. In addition, inside the second housing 12, an introduction passage 124d connecting an introduction pipe not shown in the drawings and the introduction port 124a, and a discharge passage 124e connecting the discharge port 124c and a discharge pipe not shown in the drawings are provided. In addition, inside the first housing 11 and the second housing 12, a supply passage L is provided that connects the supply port 124b and the first hydraulic pressure chamber P1, and extends across the first housing 11 and the second housing 12. Specifically, the supply passage L is composed of a first housing supply passage 116 which is provided inside the first housing 11, and a second housing supply passage 126 which is provided inside the second housing 12 and connects the supply port 124b and the first housing supply passage 116. The introduction port 124a is connected to a hydraulic pressure source not shown in the drawings via the introduction passage 124d and the introduction pipe not shown in the drawings. The supply port 124b is connected to the first hydraulic pressure chamber P1 via the supply passage L. The discharge port 124c is connected to a reservoir tank not shown in the drawings via the discharge passage 124e and the discharge pipe not shown in the drawings.

On the outer peripheral side of the rotor 210, a supply recess portion 210a and a discharge recess portion (not shown in the drawings) which extend in the direction of the rotation axis X in the form of vertical grooves are alternately arranged in parallel in the circumferential direction. Similarly, on the inner peripheral side of the sleeve 220, a right steering recess portion 220a and a left steering recess portion (not shown in the drawings) which extend in the direction of the rotation axis X in the form of vertical grooves are alternately arranged in parallel in the circumferential direction. In addition, the sleeve 220 is provided with a first communication passage 221, a second communication passage 222, a supply communication passage 223, and a discharge communication passage 224 so as to communicate the inner periphery with the outer periphery of the sleeve 220. The first communication passage 221 is opened to the right steering recess portion 220a, and the second communication passage 222 is opened to the left steering recess portion not shown in the drawings. In addition, the supply communication passage 223 or the discharge communication passage 224 is open to the protrusion not shown in the drawings, which is sandwiched between the right steering recess portion 220a and the left steering recess portion not shown in the drawings in the circumferential direction, and the supply communication passage 223 and the discharge communication passage 224 are arranged alternately in the circumferential direction.

In addition, as shown in FIGS. 1 and 2, a preload applying mechanism 6 is provided between the sector gear 32 and the rack tooth part 42 to adjust the meshing of the sector gear 32 and the rack tooth part 42 in the vicinity of the neutral position (position shown in FIG. 1) of the sector shaft 3 that corresponds to the straight-ahead steering state. This preload applying mechanism 6 is provided, as particularly shown in FIG. 2, at a position on the other end side in the tooth width direction of the first rack tooth bottom 425, which is a specific tooth bottom that meshes with the first sector tooth 321 as a center tooth, as well as at a position on the side facing the other end side of the first sector tooth 321 which is close to the second shaft portion 312.

### (Configuration of Preload Applying Mechanism)

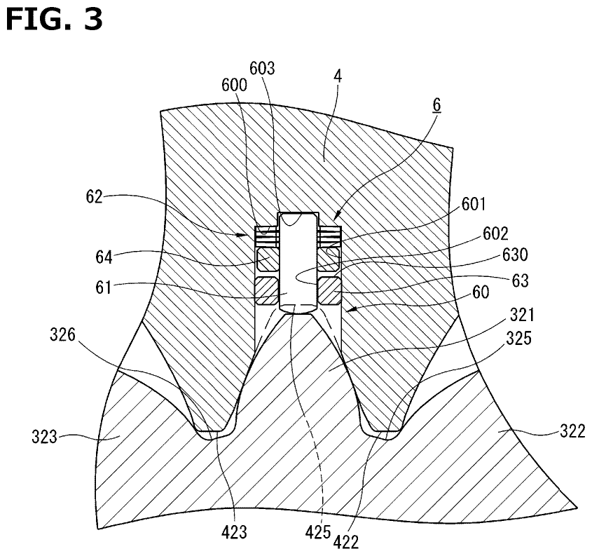

FIG. 3 is an enlarged view of a main part of FIG. 1, in which the vicinity of the preload applying mechanism 6 as a main part in FIG. 1 is enlarged and shown.

As shown in FIG. 3, the preload applying mechanism 6 is provided with a plunger receiving hole 60 formed in the first rack tooth bottom 425, a plunger 61 which is housed in the plunger receiving hole 60 so as to advance and retract, and an energizing member 62 which is interposed between the bottom of the plunger receiving hole 60 and the bottom of the plunger 61 and energizes the plunger 61 toward the first sector tooth 321.

The plunger receiving hole 60 has a substantially circular shape in cross section, and one end thereof is opened to the first rack tooth bottom 425 and the other end is closed by a bottom wall 600. Furthermore, the plunger receiving hole 60 is a round hole with a constant inner diameter in the axial direction, and is formed into a tapered stepped diameter shape by press-fitting an annular member 63 having an annular shape from the opening side. That is, the plunger receiving hole 60 includes a large diameter hole portion 601 with a relatively large diameter which is provided on the bottom wall 600 side, and a small diameter hole portion 602 with a relatively small diameter which is provided on the opening side, and is formed on the inner peripheral side of the annular member 63. In addition, between the large diameter hole portion 601 and the small diameter hole portion 602, a stepped stopper 630 is formed by the annular member 63, stepped stopper 630 which comes in contact with the after-mentioned sliding ring 64 provided on the outer peripheral side of the plunger 61 to regulate the amount of advancement of the plunger 61, namely, the protrusion amount of the plunger 61 protruding from the small diameter hole portion 602.

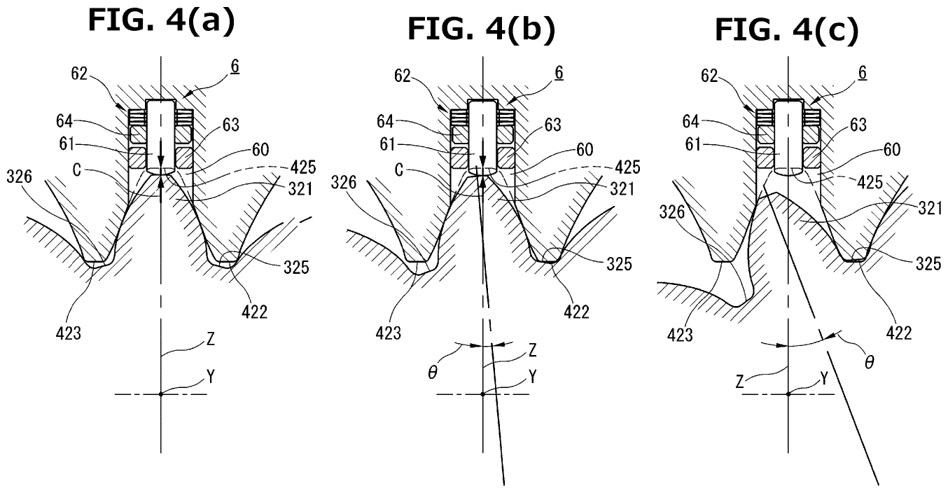

The stopper 630 does not come in contact with the sliding ring 64, and allows the plunger 61 to come in contact with the first sector tooth 321, in a state in which the rotational phase of the sector shaft 3 is near the neutral position (see FIG. 4(a)). On the other hand, in a state in which the rotational phase of the sector shaft 3 is beyond the position near the neutral position, the stopper 630 comes in contact with the sliding ring 64 and regulates the plunger 61 from coming in contact with the first sector tooth 321 (see FIG. 4(c)).

In addition, the bottom wall 600 of the plunger receiving hole 60 includes, at the middle position thereof, a recess portion 603 having a concave shape, which can receive an end portion 612 of the plunger 61 which is located on the side opposite to a distal end portion 611 of the plunger 61 which faces the first sector tooth 321. The recess portion 603 is formed in a stepped concave shape with a circular cross-section, and is provided facing the end portion 612 of the plunger 61.

In addition, the recess portion 603 has a predetermined inner diameter which is larger than the outer diameter of the end portion 612 of the plunger 61 and smaller than the inner diameter of the energizing member 62. Furthermore, the recess portion 603 has a depth greater than the processing errors that occur in the plunger receiving hole 60, the plunger 61 and the sliding ring 64, and receives the end portion 612 of the plunger 61 that is pushed back by the sector gear 32 (first sector tooth 321) in the plunger adjustment operation described below. In other words, in the plunger adjustment operation described below, the recess portion 603 receives the end portion 612 of the plunger 61 when the plunger 61 is pushed back by the first sector tooth 321, thereby avoiding the collision between the end portion 612 and the bottom wall 600 and ensuring a retraction allowance for the plunger 61.

In addition, the recess portion 603 functions in accordance with the amount of extension of the end portion 612 of the plunger 61 (amount of overlap with the energizing member 62), which extends more on the bottom wall 600 side than the sliding ring 64. Therefore, if the relative position of the plunger 61 and the sliding ring 64 is in a case where the end portion 612 of the plunger 61 does not come in contact with the bottom wall 600 when the plunger 61 is pushed in by the sector gear 32 (first sector tooth 321) in the plunger adjustment operation described below, the recess portion 603 is not a necessary component of the preload applying mechanism 6.

The plunger 61 is formed in a cylindrical shape with a constant outer diameter using resin material, and is formed with a stepped diameter by press-fitting the annular sliding ring 64 on the outer periphery of the plunger 61. In other words, the plunger 61 is configured to be movable integrally with the sliding ring 64, and is slidably housed in the plunger receiving hole 60 via the sliding ring 64. In addition, the plunger 61 has an outer diameter that is slightly smaller than the inner diameter of the annular member 63, and the distal end portion 611 which protrudes more on the distal end side that the sliding ring 64 protrudes from the small diameter hole portion 602 of the plunger receiving hole 60 and faces the outside so as to face the first sector tooth 321. Further, the distal end portion 611 of the plunger 61 has a gently curved shape, and when the sector shaft 3 rotates, it is possible to smoothly come in slidable contact with the tooth surface of the first sector tooth 321.

Here, it is desirable that the plunger 61 has an outer diameter that is slightly larger than the inner diameter of each of the energizing member 62 and the annular member 63. That is, by reducing the gap between the outer peripheral surface of the plunger 61 and the inner peripheral surface of each of the energizing member 62 and the annular member 63, it is possible to guide the advance and retraction movement of the plunger 61 by the inner peripheral surface of each of the energizing member 62 and the annular member 63, and to facilitate the advance and retraction movement of the plunger 61.

In addition, it is desirable that the plunger 61 has an axial length which allows it to pass through the inner peripheral side of the energizing member 62, and is set to have an axial length which allows it to be located near the bottom wall 600 of the plunger receiving hole 60 when the energizing member 62 is in its maximum contracted state, in the neutral position (see, for example, FIGS. 1 and 4(a)). That is, it is desirable that the plunger 61 is configured so as to overlap with the energizing member 62 over a relatively long area of the inner peripheral side of the energizing member 62 when viewed from the radial direction of the plunger 61. With this, it is possible to support the outer peripheral side of the end portion 612 of the plunger 61 with the inner peripheral side of the energizing member 62, thereby contributing to the smooth advance and retraction movement of the plunger 61.

The sliding ring 64 has a substantially annular shape, has an inner diameter that allows it to be press-fitted to the outer peripheral surface of the plunger 61, and has an outer diameter that allows it to come in slide contact with the plunger receiving hole 60. In addition, the sliding ring 64 is provided so as to face the bottom wall 600 of the plunger receiving hole 60 on one side in the energizing direction of the energizing member 62, and functions as a seating surface of the energizing member 62 that is interposed between the bottom wall 600 of the plunger receiving hole 60 and the sliding ring 64. Further, the sliding ring 64 is provided so as to face the annular member 63 on the other side in the energizing direction of the energizing member 62, and functions as a contact surface that comes in contact with the annular member 63, and by coming in contact with the annular member 63, it is used to regulate the amount of advancement of the plunger 61.

Further, the sliding ring 64 is press-fitted to the plunger 61 with a degree of fitting that allows the relative movement between the sliding ring 64 and the plunger 61 with respect to the meshing force of the sector gear 32 and rack tooth part 42 while regulating the relative movement between the sliding ring 64 and the plunger 61 with respect to the energizing force of the energizing member 62. That is, the sliding ring 64 is configured so as to advance and retract together with the plunger 61 by maintaining a fixed state with the plunger 61 in a state in which the energizing force of the energizing member 62 is applied. On the other hand, in the plunger adjustment operation described below, the sliding ring 64 is configured such that the plunger 61 can move relative to the sliding ring 64 in a state in which the meshing force of the sector gear 32 and rack tooth part 42 is applied.

The energizing member 62 has an annular or cylindrical shape whose inner peripheral side is penetrated in the energizing direction, and one end portion of the energizing member 62 is seated on the bottom wall 600 of the plunger receiving hole 60, while the other end is seated on the sliding ring 64, and it is housed between the bottom wall 600 of the plunger receiving hole 60 and the sliding ring 64 with a predetermined preload. More specifically, the energizing member 62 is applied with the predetermined preload such that the energizing force of the energizing member 62 acts on the plunger 61 even in a state in which the sliding ring 64 comes in contact with the stopper 630, and the energizing force is always applied to the plunger 61. In the present embodiment, the energizing member 62 is configured by stacking a plurality of well-known disc springs in series. The energizing member 62 is not limited to one configured by stacking a plurality of disc springs in series as in the present embodiment, and the material and shape can be changed as desired, as long as it is formed in a hollow shape and can continuously energize the plunger 61, such as a coil spring.

### (Operation Explanation for Preload Applying Mechanism)

FIG. 4 is a diagram showing a change in the protrusion amount of the plunger 61 according to a steering state, where (a) shows a neutral state with a steering angle of 0 degrees, (b) shows a steering state with a steering angle of 12 degrees, and (c) shows a steering state with a steering angle of 25 degrees.

As shown in FIG. 4(a), in the neutral state in which the steering angle is 0 degrees, the plunger 61 is in the most retracted state, the sliding ring 64 is separated from the stopper 630, and the distal end portion 611 of the plunger 61 comes in elastic contact with the tooth tip of the first sector tooth 321 based on the energizing force of the energizing member 62. In this state, the ball nut 4 is energized toward one side in the rotation direction by the reaction force generated by the distal end portion 611 of the plunger 61 coming in contact with the tooth tip of the first sector tooth 321. As a result, a distance C between the first sector tooth 321 and the first rack tooth bottom 425 becomes small, on the other end side of the sector gear 32. With this, the meshing between the first sector tooth 321 and the second and third rack teeth 422 and 423 becomes deep, and the backlash between the first sector tooth 321 and the second and third rack teeth 422 and 423 decreases.

As shown in FIG. 4(b), in the steering state in which the steering angle is 12 degrees, the plunger 61 is in a advanced state, which is a state immediately before the sliding ring 64 comes in contact with the stopper 630, and the distal end portion 611 of the plunger 61 comes in elastic contact with the tooth tip of the first sector tooth 321 based on the energizing force of the energizing member 62. In this state, by the amount of the extension of the energizing member 62 due to the advance of the plunger 61, a relatively small energizing force compared to the neutral state described above is applied to the plunger 61. That is, the ball nut 4 is energized toward one side in the rotation direction by the reaction force generated by the distal end portion 611 of the plunger 61 coming in contact with the tooth tip of the first sector tooth 321 based on an energizing force which is smaller than that in the neutral state described above. As a result, on the other end side of the sector gear 32, the distance C between the first sector tooth 321 and the first rack tooth bottom 425 decreases, and the backlash between the first sector tooth 321 and the second and third rack teeth 422 and 423 decreases.

As shown in FIG. 4(c), in the steering state in which the steering angle is 25 degrees, the plunger 61 is in the most advanced state, and the sliding ring 64 comes in contact with the stopper 630, the advance movement of the plunger 61 is regulated, and the distal end portion 611 of the plunger 61 is separated from the tooth tip of the first sector tooth 321. In this state, the distance C between the first sector tooth 321 and the first rack tooth bottom 425 does not change, and the backlash between the first sector tooth 321 and the second and third rack teeth 422 and 423 is not adjusted, because the energizing force is not applied to the ball nut 4.

### (Method for Manufacturing Steering Device)

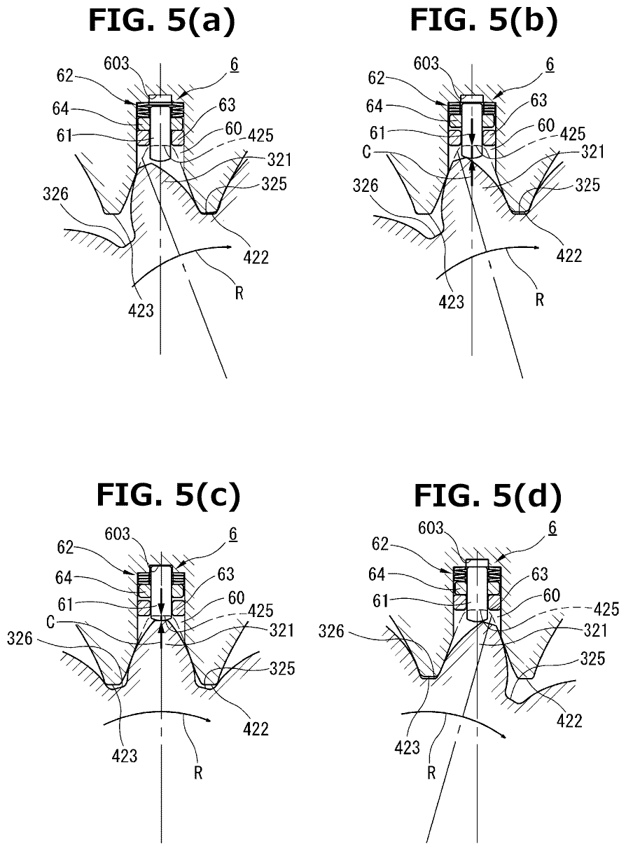

FIG. 5 is a diagram showing a plunger adjustment operation for adjusting the protrusion amount of the plunger 61 in the method for manufacturing the steering device PS1, where (a) shows a first step, (b) shows a second step, (c) shows a third step, and (d) shows the maximum advancement state of the plunger after the plunger adjustment.

In the following, the method for manufacturing the steering device PS1 will be explained. In addition, in the following explanation, the preload mechanism assembly operation for assembling the preload applying mechanism 6, which is a characteristic configuration of the steering device PS1, will be explained in the manufacturing method for the steering device PS1.

That is, the method for manufacturing the steering device PS1 includes, as the preload mechanism assembly operation, an energizing member assembly operation for assembling the energizing member 62, a sliding ring assembly operation for assembling the sliding ring 64, a plunger assembly operation for assembling the plunger 61, and a plunger adjustment operation for adjusting the relative position of the plunger 61 and the sliding ring 64.

In the energizing member assembly operation, the energizing member 62 is housed inside the plunger receiving hole 60 from the opening side. In the sliding ring assembly operation, the sliding ring 64 is assembled on the outer peripheral side of the plunger 61. In addition, the energizing member assembly operation or the plunger assembly operation can be carried out first, and either operation can be carried out first. In the plunger assembly operation, after the energizing member assembly operation, a plunger assembly 610 which is formed by integrating the plunger 61 and the sliding ring 64 is housed inside the plunger receiving hole 60 from the opening side. In the plunger adjustment operation, after the plunger assembly operation, the relative position of the plunger 61 and the sliding ring 64 is adjusted by meshing the sector gear 32 with the rack tooth part 42.

Here, the plunger adjustment operation described above mainly includes a first step, a second step and a third step which are described in detail below.

In the first step, as shown in FIG. 5(a), the sector gear 32 is rotated in one direction with respect to the rack tooth part 42 to which the preload applying mechanism 6 is assembled, and the sector gear 32 is meshed in a non-neutral position. At this point, the plunger assembly 610 is in the maximum advancement state by bringing the sliding ring 64 into contact with the stopper 630, while the first sector tooth 321 does not come in contact with the plunger 61 and is in a state just before coming in contact with the plunger 61.

In the second step, after the first step described above, the sector gear 32 is rotated in the direction (shown by an arrow R in the illustration) in which the distance C between the first sector tooth 321 and the first rack tooth bottom 425 becomes small, toward the neutral position. As a result of this rotation of the sector gear 32, the first sector tooth 321 pushes the plunger 61 in the direction opposite to the energizing direction of the energizing member 62 against the energizing force of the energizing member 62, and as shown in FIG. 5(b), the energizing member 62 is compressed to be the maximum contraction through the sliding ring 64 which moves together with the plunger 61.

In the third step, after the second step described above, in a state in which the energizing member 62 is maximally contracted (see FIG. 5(b)), the first sector tooth 321 further pushes the plunger 61 in the direction opposite to the energizing direction of the energizing member 62. With this, as shown in FIG. 5(c), the plunger 61 moves (retracts) relative to the sliding ring 64 in the direction opposite to the energizing direction of the energizing member 62. In this case, the end portion 612 of the plunger 61 which is pushed back by the first sector tooth 321 is received and housed in the recess portion 603, and the bottom wall 600 does not obstruct the retraction movement of the plunger 61. In this way, by the relative movement (retraction) of the plunger 61 to the sliding ring 64, the relative position of the plunger 61 and the sliding ring 64 is automatically adjusted to an appropriate position, such that the distal end portion 611 of the plunger 61 comes in contact with the tooth tip of the first sector tooth 321 in a state in which the energizing member 62 is maximally compressed, at the neutral position.

After that, when the sector gear 32 is rotated further in one direction, as shown in FIG. 5(d), the plunger 61 and the sliding ring 64 advance again toward the first sector tooth 321 while maintaining the relative position adjusted in the third step.

### Working Effect of the Present Embodiment

In the conventional steering device, the preload applying mechanism reduces the backlash between the rack tooth part and the sector gear near the neutral position of the sector shaft by energizing the ball nut in one rotation direction, based on the reaction force from the plunger sliding portion which is generated by the plunger, which is provided inside the ball nut and is capable of being energized toward the sector gear, coming in elastic contact with the plunger sliding portion which has a predetermined cam profile and is provided adjacent to the sector gear. However, the conventional steering device described above requires a plunger sliding portion to be provided in addition to the sector gear. Consequently, there is still room for improvement in terms of the size of the sector shaft in the axial direction, due to the need for the plunger sliding portion.

In contrast to this, the steering device PS1 according to the present embodiment is provided with: a rack tooth part 42 formed on the outer side of a ball nut 4 which is screwed onto a steering shaft 2 (second steering shaft 22) linked to a steering wheel (not shown in the drawings); a sector gear 32 which is provided to a sector shaft 3 liked to a turning wheel (not shown in the drawings, includes a center tooth (first sector tooth 321) that meshes most deeply with the rack tooth part 42 at the neutral position of the sector shaft 3 which corresponds to the straight-ahead steering state, and meshes with the rack tooth part 42 using a plurality of sector teeth (first sector tooth 321, second sector tooth 322, and third sector tooth 323) provided in the circumferential direction of the sector shaft 3; and a preload applying mechanism 6 which adjusts the meshing between the rack tooth part 42 and the sector gear 32 in the vicinity of the neutral position of the sector shaft 3, wherein the preload applying mechanism 6 includes: a plunger receiving hole 60 which is provided close to an area on one end side in the tooth width direction of a specific tooth bottom (first rack tooth bottom 425) of the rack tooth part 42 which faces the tooth tip of the center tooth (first sector tooth 321) in the vicinity of the neutral position of the sector shaft 3, and is opened to the specific tooth bottom (first rack tooth bottom 425); a plunger 61 which is housed in the plunger receiving hole 60 so as to advance and retract, and is provided such that a distal end side thereof protrudes from an opening portion facing the sector gear 32 of the plunger receiving hole 60; a sliding ring 64 which is provided to move integrally with the plunger 61 by being press-fitted to the outer peripheral side of the plunger 61, and slides with respect to the inner peripheral surface of the plunger receiving hole 60 by the advance and retraction movement of the plunger 61; and an energizing member 62 which is interposed between the bottom (bottom wall 600) of the plunger receiving hole 60 and the sliding ring 64, and energizes the plunger 61 toward the center tooth (first sector tooth 321) via the sliding ring 64, and wherein the preload applying mechanism 6 energizes the ball nut 4 in one rotation direction of the ball nut 4 based on the reaction force generated by the plunger 61 coming in elastic contact with the tooth tip of the center tooth (first sector tooth 321).

In this way, the present embodiment has a configuration that applies rotational torque as preload to the ball nut 4 in one rotation direction of the ball nut 4 based on the reaction force generated by the elastic contact of the plunger 61, which is energized by the energizing member 62, with the tooth tip of the first sector tooth 321 of the sector gear 32. Consequently, in the present embodiment, there is no need to provide a pushed part which is pushed by the plunger 61, separately from the sector gear 32, as in the conventional steering device described above. With this, it is possible to suppress the increase in the size of the sector shaft 3 due to the formation of the pushed part.

In addition, in the present embodiment, the connection between the sliding ring 64 and the plunger 61 by the press-fitting regulates the relative movement of the plunger 61 to the sliding ring 64 with respect to the energizing force of the energizing member 62, while allowing the relative movement of the plunger 61 to the sliding ring 64 with respect to the meshing force of the sector gear 32 with the rack tooth part 42.

If the sliding ring 64 is formed integrally with the plunger 61, depending on the processing accuracy (processing error) of the plunger receiving hole 60, plunger 61, sliding ring 64 and the like, there is a risk that the length of the distal end portion 611 of the plunger 61 which faces more on the sector gear 32 (first sector tooth 321) side than the sliding ring 64 becomes longer than necessary. In this case, the plunger 61 is excessively pushed in when the sector gear 32 meshes with the rack tooth part 42, as a result of which the energizing member 62 is excessively compressed, which may cause damage to the energizing member 62 or reduce its lifespan.

In order to solve this problem, in the present embodiment, the sliding ring 64 is press-fitted to the plunger 61 with a fitting degree at which the relative movement of the sliding ring 64 and the plunger 61 is allowed with respect to the meshing force of the sector gear 32 and the rack tooth part 42, while regulating the relative movement of the sliding ring 64 and plunger 61 with respect to the energizing force of the energizing member 62. With this, the sliding ring 64 and the plunger 61 integrally move depending on the degree of the energizing force of the energizing member 62, while when the sector gear 32 meshes with the rack tooth part 42, the plunger 61 is pushed in the direction opposite to the advance direction by the sector gear 32 (first sector gear 321), causing the plunger 61 to move relative to the sliding ring 64, and enabling the relative position of the plunger 61 and the sliding ring 64 to be changed to an appropriate positional relationship. As a result, regardless of machining errors in the dimensions (axial dimensions) of the plunger receiving hole 60, plunger 61 and sliding ring 64 in relation to the energizing direction of the energizing member 62, the plunger 61 can be energized with an appropriate energizing force against the sector gear 32, and an appropriate preload (rotational torque) can be applied to the ball nut 4.

In addition, the relative movement of the sliding ring 64 and the plunger 61 is allowed with respect to the meshing force of the sector gear 32 and the rack tooth part 42, thereby eliminating the risk of the energizing member 62 being excessively compressed due to the meshing of the sector gear 32 and the rack tooth part 42. Consequently, the damage to the energizing member 62 can be suppressed and the durability of the energizing member 62 can also be improved.

In addition, in the present embodiment, the plunger receiving hole 60 includes, at the bottom (bottom wall 600) on the side opposite to the opening, a recess portion 603 which can receive the end portion 612 of the plunger 61 which is located on the side opposite to the distal end portion 611 of the plunger 61 that comes in contact with the tooth tip of the center tooth (first sector tooth 321).

Depending on the length of the end portion 612 of the plunger 61 which faces more on the energizing member 62 side than the sliding ring 64, when the plunger 61 is pushed in by the center tooth (first sector tooth 321), the end portion 612 of the plunger 61 may come in contact with the bottom (bottom wall 600) of the plunger receiving hole 60, and the pushing-in (retraction movement) of the plunger 61 may be obstructed.

In contrast, in the present embodiment, a recess portion 603 which can receive the end portion 612 of the plunger 61 which is located on the side opposite to the distal end portion 611 of the plunger 61 which comes in contact with the center tooth (first sector tooth 321) of the sector gear 32 is provided on the bottom (bottom wall 600) on the side opposite to the opening of the plunger receiving hole 60. Therefore, when the plunger 61 is pushed in by the center tooth (first sector tooth 321), the distal end portion 612 of the plunger 61 is received in the recess portion 603, and there is no risk that the distal end portion 612 of the plunger 61 comes in contact with the bottom (bottom wall 600) of the plunger receiving hole 60 and the pushing-in (retraction movement) of the plunger 61 is obstructed. Consequently, the relative position of the plunger 61 and the sliding ring 64 can be adjusted to an appropriate state, regardless of the length of the distal end portion 612 of the plunger 61 that faces more on the energizing member 62 side than the sliding ring 64.

In addition, in the present embodiment, the plunger receiving hole 60 is reduced in diameter such that the opening has an inner diameter smaller than the outer diameter of the sliding ring 64, and includes a stopper 630 which regulates the protrusion amount of the plunger 61 by coming in contact with the sliding ring 64. In a state in which the rotational phase of the sector shaft 3 is in the vicinity of the neutral position, the sliding ring 64 does not come in contact with the stopper 630, and the contact between the plunger 61 and the center tooth (first sector tooth 321) is allowed, while in a state in which the rotational phase of the sector shaft 3 exceeds the vicinity of the neutral position, the sliding ring 64 comes in contact with the stopper 630 and the contact between the plunger 61 and the center tooth (first sector tooth 321) is regulated.

That is, in the present embodiment, when the rotational phase of the sector shaft 3 is in the vicinity of the neutral position of the steering, the contact between the plunger 61 and the first sector tooth 321 is allowed, while when the rotational phase of the sector shaft 3 exceeds the vicinity of the neutral position, the contact between the plunger 61 and the first sector tooth 321 is regulated by the stopper 630.

In this way, in the present embodiment, by regulating the protrusion amount of the plunger 61 using the stopper 630, it is possible to adjust the meshing between the rack tooth part 42 and the sector gear 32 only in the vicinity of the neutral position of the sector shaft 3, where rigidity is required. In other words, outside the vicinity of the neutral position where rigidity is not particularly required, by regulating the contact between the plunger 61 and the first sector gear 321, it is possible to suppress the deterioration of the steering feel, such as so-called “grinding” feeling that occurs when the plunger 61 comes in slide contact with the first sector gear 321.

In addition, in the present embodiment, the stopper 630 is formed by disposing the annular member 63 in the opening of the plunger receiving hole 60. Therefore, in the present embodiment, the protrusion amount of the plunger 61 can be regulated with a relatively simple configuration, without forming a complex cam profile, as in the conventional steering device described above. With this, it is possible to contribute to reducing the manufacturing costs of the steering device PS1.

In addition, in the present embodiment, the tooth bottom of the sector gear 32 has a straight shape that is substantially parallel to the rotation axis Y of the sector shaft 3. In other words, in the present embodiment, the tooth bottom of the sector gear 32 is not tapered, and the meshing of the rack tooth part 42 and the sector gear 32 can be adjusted by the preload applying mechanism 6 alone, without providing a mechanism (backlash adjustment mechanism) to adjust the meshing of the rack tooth part 42 and the sector gear 32 in addition to the preload applying mechanism 6. Consequently, the configuration of the steering device PS1 is simplified, and it is possible to contribute to improving the productivity and reducing manufacturing costs of the steering device PS1.

In addition, a method for manufacturing the steering device PS1 according to the present embodiment: includes an energizing member assembly operation in which the energizing member 62 is housed in the plunger receiving hole 60; a sliding ring assembly operation in which the sliding ring 64 is assembled to the plunger 61; a plunger assembly operation in which the plunger 61 assembled with the sliding ring 64 is assembled to the plunger receiving hole 60; and a plunger adjustment operation in which the sector gear 32 meshes with the rack tooth part 42 and the relative position of the plunger 61 and the sliding ring 64 is adjusted, after the plunger assembly operation, wherein the plunger adjustment operation includes: a first step in which the sector gear 32 is rotated in one direction with respect to the rack tooth part 42 to which the preload applying mechanism 6 is assembled, and the sector gear 32 is meshed in a non-neutral position; a second step in which the sector gear 32 is rotated in the direction where the distance C between the center tooth (first sector tooth 321) and the specific tooth bottom (first rack tooth base 425) becomes small, toward the neutral position, and the center tooth (first sector tooth 321) pushes the plunger 61 in the direction opposite to the energizing direction of the energizing member 62 against the energizing force of the energizing member 62, to compresses the energizing member 62 until being maximally contracted via the sliding ring 64 which moves integrally with the plunger 61, after the first step; and a third step in which in a state in which the energizing member 62 is maximally contracted, the center tooth (first sector tooth 321) further pushes the plunger 61 in the direction opposite to the energizing direction of the energizing member 62, and the plunger 61 is moved relative to the sliding ring 64 in the direction opposite to the energizing direction of the energizing member 62, after the second step.

In this way, in the present embodiment, in the plunger adjustment operation, the center tooth (first sector tooth 321) further pushes the plunger 61 when the energizing member 62 is at maximum contraction, to move the plunger 61 relative to the sliding ring 64, and the relative position of the plunger 61 and the sliding ring 64 can be changed to an appropriate positional relationship. With this, the plunger 61 is energized against the sector gear 32 with an appropriate energizing force, and an appropriate preload can be applied to the ball nut 4, regardless of machining errors in the axial dimensions of the plunger receiving hole 60, plunger 61, sliding ring 64, and the like.

In addition, in the plunger adjustment operation, when the center tooth (first sector tooth 321) pushes the plunger 61 further in a state in which the energizing member 62 is maximally compressed, the plunger 61 is allowed to move relative to the sliding ring 64, and even if, for example, the protrusion amount of the plunger 61 becomes larger than a specified dimension in relation to the bottom wall 600 of the plunger receiving hole 60 due to the processing errors of the axial direction dimensions of the plunger receiving hole 60, plunger 61, sliding ring 64, and the like, there is no risk of the energizing member 62 being excessively compressed. With this, the energizing member 62 is suppressed from being damaged and the durability of the energizing member 62 is also improved.

Furthermore, according to the method for manufacturing the steering device PS1 described above, the plunger receiving hole 60 includes, at the bottom (bottom wall 600) on the side opposite to the opening, a recess portion 603 which can receive the end portion 612 of the plunger 61 which is located on the side opposite to the distal end portion 611 that comes in contact with the tooth tip of the center tooth (first sector tooth 321), and in the third step, when the plunger 61 moves relative to the sliding ring 64 in the direction opposite to the energizing direction of the energizing member 62, the end portion 612 of the plunger 61 is received in the recess portion 603.

In the third step, depending on the length of the end portion 612 of the plunger 61 that faces more on the energizing member 62 side than the sliding ring 64, when the plunger 61 is pushed in by the center tooth (first sector tooth 321), the end portion 612 of the plunger 61 may come in contact with the bottom (bottom wall 600) of the plunger receiving hole 60, and there is a risk that the plunger 61 is obstructed from being pushed in (retraction movement).

In contrast, in the present embodiment, a recess portion 603 which can receive the end portion 612 of the plunger 61 which is located on the side opposite to the distal end portion 611 of the plunger 61 which comes in contact with the center tooth (first sector tooth 321) of the sector gear 32 is provided in the bottom (bottom wall 600) on the opposite side of the opening of the plunger receiving hole 60. With this, in the third step of the plunger adjustment operation, when the plunger 61 is pushed in by the center tooth (first sector tooth 321), the end portion 612 of the plunger 61 is received in the recess portion 603, and there is no risk that the end portion 612 of the plunger 61 comes in contact with the bottom (bottom wall 600) of the plunger receiving hole 60 and the pushing-in (retraction movement) of the plunger 61 is not obstructed. Consequently, it is possible to adjust the relative position of the plunger 61 and the sliding ring 64 to an appropriate state, regardless of the length of the end portion 612 of the plunger 61 that faces more on the energizing member 62 side than the sliding ring 64.

### Second Embodiment

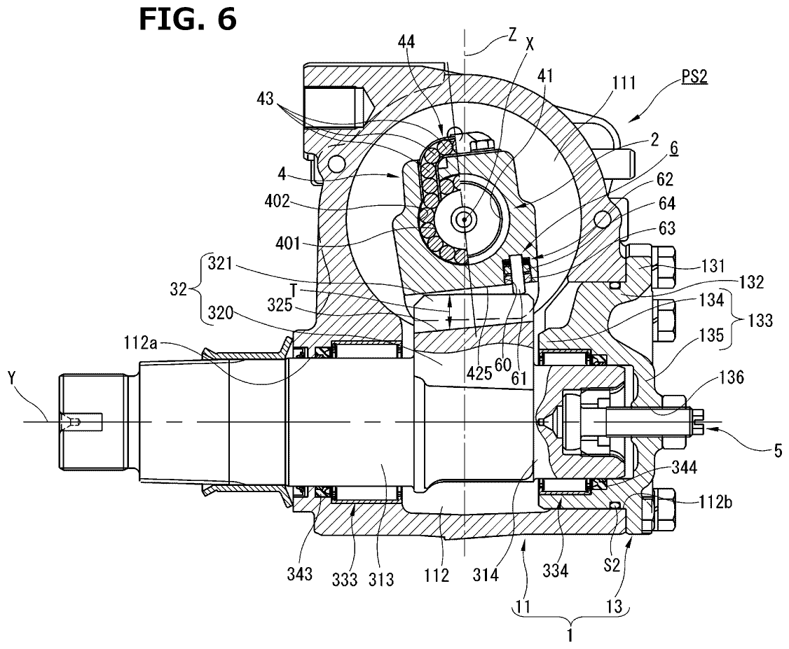

FIG. 6 shows a second embodiment of the steering device according to the present invention. In this embodiment, the configuration of the sector shaft 3 is mainly changed, and a backlash adjustment mechanism which can adjust the backlash of the sector gear 32 to the rack tooth part 42 is provided separately from the preload applying mechanism 6. The other configuration is the same as that of the first embodiment described above. Therefore, the same symbols are used for the same components as the first embodiment, and the specific description is omitted.

FIG. 6 shows a second steering device PS2 according to the second embodiment of the present invention, and is a sectional view of the steering device PS2 corresponding to the A-A line sectional view of FIG. 1.

As shown in FIG. 6, in the steering device PS2 according to the present embodiment, the sector shaft part 31 is configured to have one end side from the sector gear 32 as a large diameter shaft portion 313 having a relatively large diameter, and the other end side from the sector gear 32 as a small diameter shaft portion 314 having a relatively small diameter. One end side of the large diameter shaft portion 313 is connected to a pitman arm (not shown), and the other end is rotatably supported by a large diameter bearing 333 housed on the inner peripheral side of the second opening 112a. That is, the large diameter shaft portion 313 is formed to have a relatively large diameter in order to ensure rigidity that can withstand a large torque, to apply a large torque to a turning wheel (not shown) via the pitman arm (not shown) connected to the one end portion of the large diameter shaft portion 313.

In addition, a large diameter seal member 343 is provided on one end side of the large diameter bearing 333, which can seal the space between the outer peripheral surface of the large diameter shaft portion 313 and the inner peripheral surface of the second opening 112a. With this, the hydraulic fluid filled inside the housing 1 (sector shaft housing 112) is suppressed from leaking out through the second opening 112a.

On the other hand, the small diameter shaft 314 is rotatably supported by a small diameter bearing 334 housed on the inner peripheral side of the third housing cylindrical portion 134. That is, the small diameter shaft portion 314 is used to rotatably support the other end side of the sector shaft 3, and since a large torque such as that applied to the large diameter shaft portion 313 is not applied, a high rigidity which can withstand the large torque is not necessary, and the small diameter shaft portion 314 is therefore formed with a relatively small diameter.

In addition, the small diameter bearing 334 is provided with, on the other end side thereof, a small diameter seal member 344 which can seal the space between the outer peripheral surface of the small diameter shaft portion 314 and the inner peripheral surface of the third housing cylindrical portion 134 in a liquid-tight manner. With this, the hydraulic fluid filled inside the housing 1 (sector shaft housing 112) can be suppressed from leaking out through the female screw hole 136 described below.

The sector gear 32 is configured as a so-called tapered gear. That is, as shown in FIG. 6, the sector gear 32 has a first sector gear bottom 325 located between the first sector tooth 321 and the second sector tooth 322, and a second sector gear bottom 326 located between the first sector tooth 321 and the third sector tooth 323, which are configured by tapered surfaces with the tooth height T of the first sector tooth 321, second sector tooth 322 and third sector tooth 323 gradually increasing toward one end of the sector shaft 3.

In addition, in accordance with the above tapered gear configuration, a female screw hole 136 which penetrates along the rotation axis Y is formed in the third housing end wall 135. An adjustment screw 5 is screwed in from the other end (outside) of the third housing 13 via the female screw hole 136. The adjustment screw 5 is screwed in while coming in contact with the other end (small diameter shaft portion 314) of the sector shaft 3, and advances to one end side to energize the sector shaft 3 toward one end side. That is, the sector shaft 3 moves toward one end side by the screwing-in of the adjustment screw 5, and the gaps between the first sector tooth bottom 325 and the second rack tooth 422 and between the second sector tooth bottom 326 and the third rack tooth 423 decrease, and thereby it is possible to reduce the backlash of the sector gear 32 to the rack tooth part 42.

In this way, in the present embodiment, a backlash adjustment mechanism is provided which is composed of a sector gear 32 configured by the tapered gear mentioned above and an adjustment screw 5 that energizes the sector shaft 3, and can adjust the backlash between the sector gear 32 and the rack tooth part 42 by manually rotating (screwing in) the adjustment screw 5. With this, it is possible to adjust the backlash between the sector gear 32 and rack tooth part 42, which increases due to wearing on the sector gear 32 and rack tooth part 42, when servicing the vehicle.

As described above, in the steering device PS2 according to the present embodiment, the tooth bottom of the sector gear 32 (the first sector tooth bottom 325 and the second sector tooth bottom 326) has a tapered surface in which the tooth height T of the sector gear 32 gradually increases toward one end side in the axial direction of the sector shaft 3, and the sector shaft 3 is movable toward one end side in the axial direction of the sector shaft 3 by the adjustment screw 5 screwed in from the other end portion in the axial direction of the sector shaft 3 through the female screw hole 136 formed in the end wall (third housing 13) of the housing 1 (first housing 11) that houses the sector shaft 3.

In this way, in the present embodiment, the first sector tooth bottom 325 and the second sector tooth bottom 326 of the sector gear 32 have tapered gear shapes with tapered surfaces, and it is possible to adjust the meshing between the rack tooth part 42 and the sector gear 32 by moving the sector shaft 3 toward one end side in the axial direction using the adjusting screw 5. With this, an appropriate meshing of the rack tooth part 42 and the sector gear 32 can be ensured not only in the vicinity of the neutral position of the sector shaft 3, but also throughout the entire range of rotation of the sector shaft 3.

In addition, in the present embodiment, one end side in the axial direction of the sector shaft 3 across the sector gear 32 which is connected to the pitman arm (not shown) is formed to have a relatively large diameter and the other end side in the axial direction across the sector gear 32 is formed to have a smaller diameter than that on one end side in the axial direction, and the plunger receiving hole 60 is opened at an end portion of the end portions in the tooth width direction of a specific tooth bottom (first rack tooth bottom 425) which corresponds to the other end side of the sector shaft 3.

In this way, in the present embodiment, the plunger receiving hole 60 which composes the preload applying mechanism 6 is located on the small diameter shaft 314 side, where the sector shaft 3 has a relatively small diameter. With this, the space where the preload applying mechanism 6 can be disposed is increased by the reduced diameter of the sector shaft 31 like the small diameter shaft 314, and the preload applying mechanism 6 can be positioned further away from the center of rotation of the ball nut 4. Consequently, it is possible to apply a larger rotational torque to the ball nut 4, and the meshing of the first sector tooth 321 with the second and third rack teeth 422 and 423 can be adjusted more effectively.

The present invention is not limited to the configuration shown in each of the above-mentioned embodiments, and in addition to the detailed configuration of the steering device which is not directly related to the configuration of the present invention, such as the configuration of the steering shaft 2, the input mode for the steering shaft 2 and the shapes of the sector gear 32 and the rack tooth part 42, the configuration of the preload applying mechanism 6 which is directly related to the configuration of the present invention, such as the specific mode of the plunger 61 and the energizing member 62, the presence of the recess portion 603, and the dimensions of the plunger 61 and the sliding ring 64, can be freely changed according to the specifications of the steering device and vehicle to be applied without departing from the scope and the spirit of the present invention.

1. A steering device comprising:
a rack tooth part formed on an outer side of a ball nut which is screwed onto a steering shaft linked to a steering wheel;
a sector gear which is provided to a sector shaft linked to a turning wheel, includes a center tooth that meshes most deeply with the rack tooth part at a neutral position of the sector shaft which corresponds to a straight-ahead steering state, and meshes with the rack tooth part using a plurality of sector teeth provided in a circumferential direction of the sector shaft; and
a preload applying mechanism which adjusts a meshing between the rack tooth part and the sector gear in a vicinity of the neutral position of the sector shaft,
wherein the preload applying mechanism includes:
a plunger receiving hole which is provided close to an area on one end side in a tooth width direction of a specific tooth bottom of the rack tooth part which faces a tooth tip of the center tooth in the vicinity of the neutral position of the sector shaft, and is opened to the specific tooth bottom;
a plunger which is housed in the plunger receiving hole so as to advance and retract, and is provided such that a distal end side thereof protrudes from an opening facing the sector gear of the plunger receiving hole;
a sliding ring which is provided to move integrally with the plunger by being press-fitted to an outer peripheral side of the plunger, and slides with respect to an inner peripheral surface of the plunger receiving hole by the advance and retraction movement of the plunger; and
an energizing member which is interposed between a bottom of the plunger receiving hole and the sliding ring, and energizes the plunger toward the center tooth via the sliding ring, and
wherein the preload applying mechanism energizes the ball nut in one rotation direction of the ball nut based on a reaction force generated by the plunger coming in elastic contact with the tooth tip of the center tooth.

2. The steering device according to claim 1,
wherein a connection of the sliding ring and the plunger by the press-fitting regulates a relative movement of the plunger to the sliding ring with respect to an energizing force of the energizing member, while allowing the relative movement of the plunger to the sliding ring with respect to a meshing force of the sector gear with the rack tooth part.

3. The steering device according to claim 2,
wherein the plunger receiving hole includes, at the bottom on a side opposite to the opening, a recess portion which can receive an end portion of the plunger which is located on a side opposite to a distal end portion of the plunger that comes in contact with the tooth tip of the center tooth.

4. The steering device according to claim 2,
wherein the plunger receiving hole is reduced in diameter such that the opening has an inner diameter smaller than an outer diameter of the sliding ring, and includes a stopper which regulates a protrusion amount of the plunger by coming in contact with the sliding ring,
wherein in a state in which a rotational phase of the sector shaft is in the vicinity of the neutral position, the sliding ring does not come in contact with the stopper, and a contact between the plunger and the center tooth is allowed, and
wherein in a state in which the rotational phase of the sector shaft exceeds the vicinity of the neutral position, the sliding ring comes in contact with the stopper and the contact between the plunger and the center tooth is regulated.

5. The steering device according to claim 1,
wherein a tooth bottom of the sector gear has a flat surface that is parallel to a rotation axis of the sector shaft.

6. The steering device according to claim 1,
wherein a tooth bottom of the sector gear has a tapered surface in which a tooth height of the sector gear gradually increases toward one end side in an axial direction of the sector shaft, and
wherein the sector shaft is movable toward one end side in the axial direction of the sector shaft by an adjustment screw screwed from an other end portion in the axial direction of the sector shaft through a female screw hole formed in an end wall of a housing that houses the sector shaft.

7. The steering device according to claim 1,
wherein one end side in an axial direction of the sector shaft across the sector gear which is connected to a pitman arm is formed to have a relatively large diameter and an other end side in the axial direction across the sector gear is formed to have a smaller diameter than that on one side in the axial direction of the sector shaft, and
wherein the plunger receiving hole is opened at an end portion of end portions in the tooth width direction of the specific tooth bottom which corresponds to the other end side in the axial direction of the sector shaft.

8. A method for manufacturing the steering device according to claim 1, the method comprising:
an energizing member assembly operation in which the energizing member is housed in the plunger receiving hole;
a sliding ring assembly operation in which the sliding ring is assembled to the plunger;
a plunger assembly operation in which the plunger assembled with the sliding ring is assembled to the plunger receiving hole; and
a plunger adjustment operation in which the sector gear meshes with the rack tooth part and a relative position of the plunger and the sliding ring is adjusted, after the plunger assembly operation,
wherein the plunger adjustment operation includes:
a first step in which the sector gear is rotated in one direction with respect to the rack tooth part to which the preload applying mechanism is assembled, and the sector gear is meshed in a non-neutral position;
a second step in which the sector gear is rotated in a direction where a distance between the center tooth and the specific tooth bottom becomes small, toward the neutral position, and the center tooth pushes the plunger in a direction opposite to an energizing direction of the energizing member against an energizing force of the energizing member, to compress the energizing member until being maximally contracted via the sliding ring which moves integrally with the plunger, after the first step; and
a third step in which in a state in which the energizing member is maximally contracted, the center tooth further pushes the plunger in the direction opposite to the energizing direction of the energizing member, and the plunger is moved relative to the sliding ring in the direction opposite to the energizing direction of the energizing member, after the second step.

9. The method for manufacturing the steering device according to claim 8,
wherein the plunger receiving hole includes, at the bottom on the side opposite to the opening, a recess portion which can receive an end portion of the plunger which is located on a side opposite to a distal end portion of the plunger that comes in contact with the tooth tip of the center tooth, and
wherein in the third step, when the plunger moves relative to the sliding ring in the direction opposite to the energizing direction of the energizing member, the end portion of the plunger is received in the recess portion.
